(19) United States
(12) Patent Application Publication
(10) Pub. No.: US 2018/0088853 A1
(43) Pub. Date: Mar. 29, 2018

(54) Multi-Level System Memory Having Near Memory Space Capable Of Behaving As Near Memory Cache or Fast Addressable System Memory Depending On System State

(71) Applicant: Intel Corporation, Santa Clara, CA (US)

(72) Inventors: Jagadish B. KOTRA, State College, PA (US); Alaa R. ALAMELDEEN, Hillsboro, OR (US); Christopher B. WILKERSON, Portland, OR (US); Jaewoong SIM, Atlanta, GA (US)

(21) Appl. No.: 15/276,677

(22) Filed: Sep. 26, 2016

(51) Int. Cl. G06F 3/06; G06F 12/0842

(52) U.S. Cl. CPC G06F 3/0634; G06F 3/061; G06F 2212/62; G06F 12/0842; G06F 3/067

(57) ABSTRACT

A method is described. The method includes performing the following in a computing system having a multi-level system memory, the multi-level system memory having a first level and a second level: switching between utilization of the first level as a cache for the second level and separately addressable system memory depending on a state of the computing system.

### FIELD OF INVENTION

The field of invention pertains generally to the computing sciences, and, more specifically, to a multi-level system memory having near memory space capable of behaving as near memory cache or fast addressable system memory depending on system state.

### BACKGROUND

Computing systems typically include a system memory (or main memory) that contains data and program code of the software code that the system's processor(s) are currently executing. A pertinent issue in many computer systems is the system memory. Here, as is understood in the art, a computing system operates by executing program code stored in system memory. The program code when executed reads and writes data from/to system memory. As such, system memory is heavily utilized with many program codes and data reads as well as many data writes over the course of the computing system's operation. Finding ways to improve system memory is therefore a motivation of computing system engineers.

### FIGURES

A better understanding of the present invention can be obtained from the following detailed description in conjunction with the following drawings, in which:

FIG. 1 shows a multi-level system memory;

FIG. 2 shows a multi level system memory approach where a segment of near memory space can be used, depending on system state, as a region of faster system memory having its own dedicated system memory address range, or, as cache support region for multiple segments of far memory space;

FIG. 3 shows a base state where pages are kept in the segments of a group having a physical address that matches their own logical address;

FIGS. 4a through 4c show a sequence where a near memory segment acts as a cache for one of the far memory segments in a group rather than a separately allocated region of system memory;

FIGS. 5a through 5g depict an example of the behavior of page manipulation and a table entry used to keep track of page allocations;

FIG. 6 shows a methodology;

FIG. 7 shows a computing system.

### DETAILED DESCRIPTION

### 1.0 Multi-Level System Memory

1.a. Multi-Level System Memory Overview

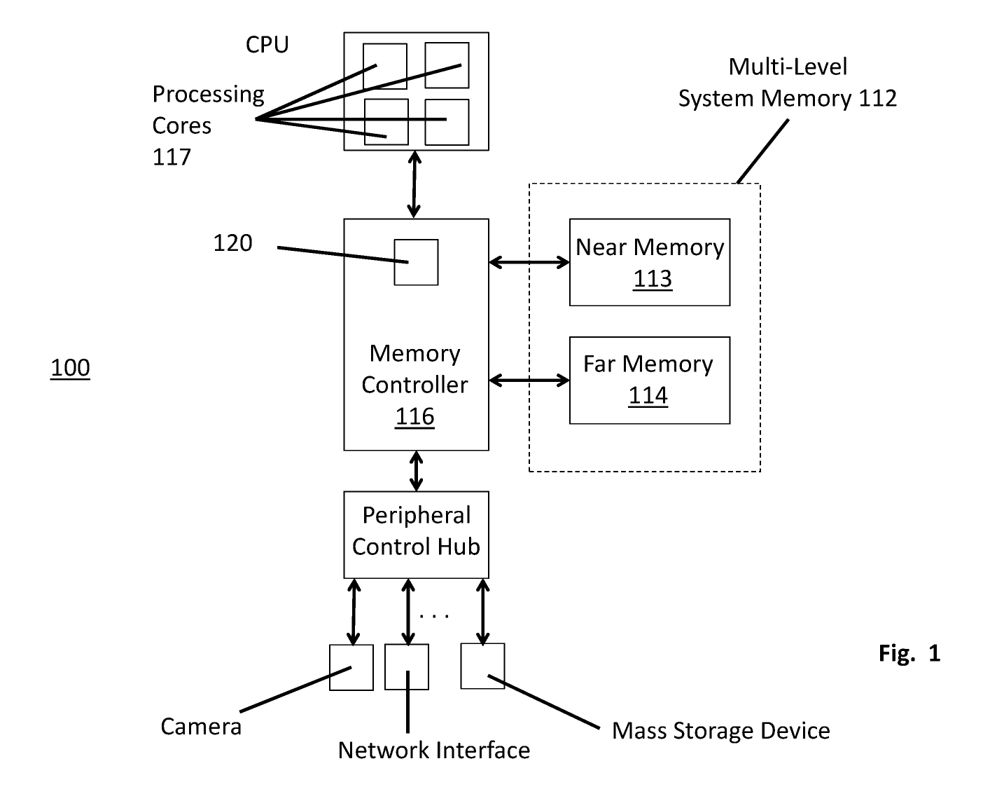

One of the ways to improve system memory performance is to have a multi-level system memory. FIG. 1 shows an embodiment of a computing system 100 having a multi-tiered or multi-level system memory 112. According to various embodiments, a smaller, faster near memory 113 may be utilized as a cache for a larger far memory 114.

The use of cache memories for computing systems is well-known. In the case where near memory 113 is used as a cache, near memory 113 is used to store an additional copy of those data items in far memory 114 that are expected to be more frequently called upon by the computing system. The near memory cache 113 has lower access times than the lower tiered far memory 114 region. By storing the more frequently called upon items in near memory 113, the system memory 112 will be observed as faster because the system will often read items that are being stored in faster near memory 113. For an implementation using a write-back technique, the copy of data items in near memory 113 may contain data that has been updated by the central processing unit (CPU), and is thus more up-to-date than the data in far memory 114. The process of writing back ‘dirty’ cache entries to far memory 114 ensures that such changes are not lost.

According to some embodiments, for example, the near memory 113 exhibits reduced access times by having a faster clock speed than the far memory 114. Here, the near memory 113 may be a faster (e.g., lower access time), volatile system memory technology (e.g., high performance dynamic random access memory (DRAM)) and/or SRAM memory cells co-located with the memory controller 116. By contrast, far memory 114 may be either a volatile memory technology implemented with a slower clock speed (e.g., a DRAM component that receives a slower clock) or, e.g., a non volatile memory technology that may be slower (e.g., longer access time) than volatile/DRAM memory or whatever technology is used for near memory.

For example, far memory 114 may be comprised of an emerging non volatile random access memory technology such as, to name a few possibilities, a phase change based memory, three dimensional crosspoint memory device, or other byte addressable nonvolatile memory devices, “write-in-place” non volatile main memory devices, memory devices that use chalcogenide phase change material (e.g., glass), single or multiple level flash memory, multi-threshold level flash memory, a ferro-electric based memory (e.g., FRAM), a magnetic based memory (e.g., MRAM), a spin transfer torque based memory (e.g., STT-RAM), a resistor based memory (e.g., ReRAM), a Memristor based memory, universal memory, Ge2Sb2Te5 memory, programmable metallization cell memory, amorphous cell memory, Ovshinsky memory, etc.

Such emerging non volatile random access memory technologies typically have some combination of the following: 1) higher storage densities than DRAM (e.g., by being constructed in three-dimensional (3D) circuit structures (e.g., a crosspoint 3D circuit structure)); 2) lower power consumption densities than DRAM (e.g., because they do not need refreshing); and/or, 3) access latency that is slower than DRAM yet still faster than traditional non-volatile memory technologies such as FLASH. The latter characteristic in particular permits various emerging non volatile memory technologies to be used in a main system memory role rather than a traditional mass storage role (which is the traditional architectural location of non volatile storage).

Regardless of whether far memory 114 is composed of a volatile or non volatile memory technology, in various embodiments far memory 114 acts as a true system memory in that it supports finer grained data accesses (e.g., cache lines) rather than larger based accesses associated with traditional, non volatile mass storage (e.g., solid state drive (SSD), hard disk drive (HDD)), and/or, otherwise acts as an (e.g., byte) addressable memory that the program code being executed by processor(s) of the CPU operate out of. However, far memory 114 may be inefficient when accessed for a small number of consecutive bytes (e.g., less than 128 bytes) of data, the effect of which may be mitigated by the presence of near memory 113 operating as cache which is able to efficiently handle such requests.

Because near memory 113 acts as a cache, near memory 113 may not have formal addressing space. Rather, in some cases, far memory 114 defines the individually addressable memory space of the computing system's main memory. In various embodiments near memory 113 acts as a cache for far memory 114 rather than acting a last level CPU cache. Generally, a CPU cache is optimized for servicing CPU transactions, and will add significant penalties (such as cache snoop overhead and cache eviction flows in the case of hit) to other memory users such as Direct Memory Access (DMA)-capable devices in a Peripheral Control Hub. By contrast, a memory side cache is designed to handle all accesses directed to system memory, irrespective of whether they arrive from the CPU, from the Peripheral Control Hub, or from some other device such as display controller.

For example, in various embodiments, system memory is implemented with dual in-line memory module (DIMM) cards where a single DIMM card has both volatile (e.g., DRAM) and (e.g., emerging) non volatile memory semiconductor chips disposed in it. The DRAM chips effectively act as an on board cache for the non volatile memory chips on the DIMM card. Ideally, the more frequently accessed cache lines of any particular DIMM card will be accessed from that DIMM card's DRAM chips rather than its non volatile memory chips. Given that multiple DIMM cards may be plugged into a working computing system and each DIMM card is only given a section of the system memory addresses made available to the processing cores 117 of the semiconductor chip that the DIMM cards are coupled to, the DRAM chips are acting as a cache for the non volatile memory that they share a DIMM card with rather than a last level CPU cache.

In other configurations DIMM cards having only DRAM chips may be plugged into a same system memory channel (e.g., a DDR channel) with DIMM cards having only non volatile system memory chips. Ideally, the more frequently used cache lines of the channel are in the DRAM DIMM cards rather than the non volatile memory DIMM cards. Thus, again, because there are typically multiple memory channels coupled to a same semiconductor chip having multiple processing cores, the DRAM chips are acting as a cache for the non volatile memory chips that they share a same channel with rather than as a last level CPU cache.

In yet other possible configurations or implementations, a DRAM device on a DIMM card can act as a memory side cache for a non volatile memory chip that resides on a different DIMM and is plugged into a different channel than the DIMM having the DRAM device. Although the DRAM device may potentially service the entire system memory address space, entries into the DRAM device are based in part from reads performed on the non volatile memory devices and not just evictions from the last level CPU cache. As such the DRAM device can still be characterized as a memory side cache.

In another possible configuration, a memory device such as a DRAM device functioning as near memory 113 may be assembled together with the memory controller 116 and processing cores 117 onto a single semiconductor device or within a same semiconductor package. Far memory 114 may be formed by other devices, such as slower DRAM or non-volatile memory and may be attached to, or integrated in that device.

As described at length above, near memory 113 may act as a cache for far memory 114. In various embodiments, the memory controller 116 and/or near memory 213 may include local cache information (hereafter referred to as “Metadata”) 120 so that the memory controller 116 can determine whether a cache hit or cache miss has occurred in near memory 113 for any incoming memory request. The metadata may also be stored in near memory 113.

In the case of an incoming write request, if there is a cache hit, the memory controller 116 writes the data (e.g., a 64-byte CPU cache line) associated with the request directly over the cached version in near memory 113. Likewise, in the case of a cache miss, in an embodiment, the memory controller 116 also writes the data associated with the request into near memory 113, potentially first having fetched from far memory 114 any missing parts of the data required to make up the minimum size of data that can be marked in Metadata as being valid in near memory 113, in a technique known as ‘underfill’. However, if the entry in the near memory cache 113 that the content is to be written into has been allocated to a different system memory address and contains newer data than held in far memory 114 (i.e. it is dirty), the data occupying the entry must be evicted from near memory 113 and written into far memory 114.

In the case of an incoming read request, if there is a cache hit, the memory controller 116 responds to the request by reading the version of the cache line from near memory 113 and providing it to the requestor. By contrast, if there is a cache miss, the memory controller 116 reads the requested cache line from far memory 114 and not only provides the cache line to the requestor but also writes another copy of the cache line into near memory 113. In many cases, the amount of data requested from far memory 114 and the amount of data written to near memory 113 will be larger than that requested by the incoming read request. Using a larger data size from far memory or to near memory increases the probability of a cache hit for a subsequent transaction to a nearby memory location.

In general, cache lines may be written to and/or read from near memory and/or far memory at different levels of granularity (e.g., writes and/or reads only occur at cache line granularity, and, e.g., byte addressability for writes/or reads is handled internally within the memory controller), byte granularity (e.g., true byte addressability in which the memory controller writes and/or reads only an identified one or more bytes within a cache line), or granularities in between. Additionally, note that the size of the cache line maintained within near memory and/or far memory may be larger than the cache line size maintained by CPU level caches. Different types of near memory caching architecture are possible (e.g., direct mapped, set associative, etc.).

In still other embodiments, at least some portion of near memory 113 has its own system address space apart from the system addresses that have been assigned to far memory 114 locations. In this case, the portion of near memory 113 that has been allocated its own system memory address space acts, e.g., as a higher priority level of system memory (because it is faster than far memory) rather than as a memory side cache. In other or combined embodiments, some portion of near memory 113 may also act as a last level CPU cache.

### 2.0 Multi-Level System Memory Having Near Memory Space Capable of Behaving as Near Memory Cache or Fast Addressable System Memory Depending on System State

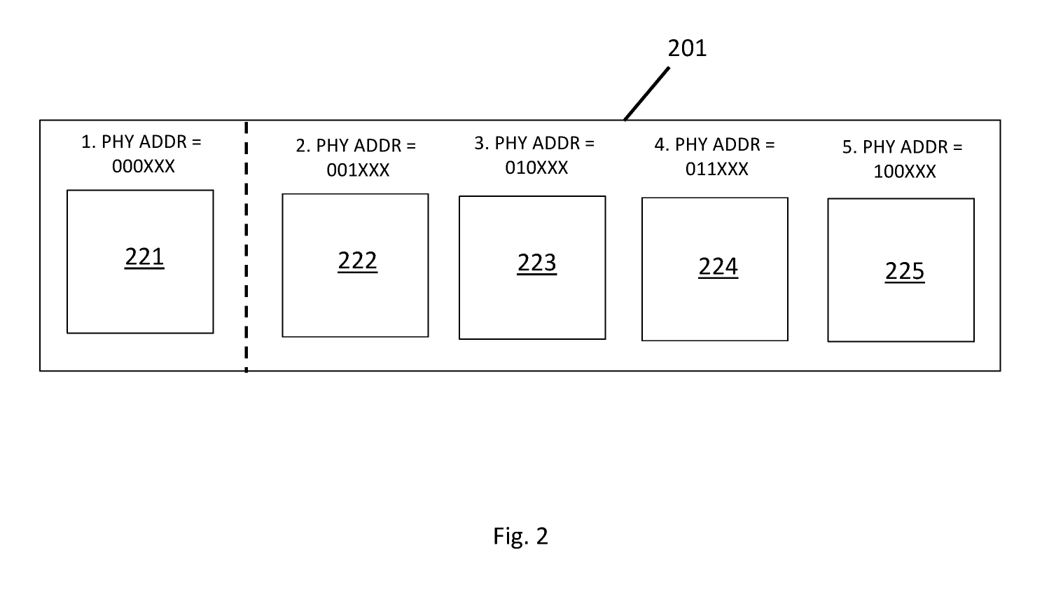

FIG. 2 shows a multi level system memory approach where a segment of near memory space 221 can be used, depending on system state, as a region of faster system memory having its own dedicated system memory address range, or, as a cache support region for multiple segments of far memory space 222 through 225. Here, each segment 221 through 225 observed in FIG. 2 corresponds to actual system memory storage resources in a computing system. Segment 221 corresponds to a region of faster (e.g., DRAM) storage that can be accessed within system memory physical address range 000XXX. By contrast, each of segments 222 through 225 correspond to different regions of slower far memory (e.g., composed of reduced clock speed DRAM or an emerging non volatile system memory technology) that can accessed within system memory physical address ranges 001XXX, 010XXX, 011XXX and 100XXX respectively.

Here, as can be appreciated from the XXX component of the address range associated with each of the aforementioned segments, each segment contains multiple separately addressable system memory storage regions. That is, the critical bits that define which segment is being addressed (e.g., 000 for segment 221, 001 for segment 222, etc.) are higher order address bits that allow for lower ordered address bits (XXX) to uniquely identify/address any one of multiple separately accessible data units (e.g., cache lines) that are kept within the segment. For example, if XXX corresponds to any three bit pattern, then, e.g., eight different cache lines may be separately stored in each segment. Note that three lower ordered bits XXX as depicted in FIG. 2 is only exemplary and in practice many more lower ordered bits may be used to effect storage of many more separately accessible data units (e.g., cache lines) within a segment.

In various embodiments, each of segments 221 through 225 corresponds to an amount of system memory storage space used to store a page of system memory data. Here, as is known in the art, system software such as a virtual machine monitor (VMM), operating system instance or application software program organizes its data and/or instructions into pages of information that are separately moved between system memory and mass block/sector non volatile storage (such as a disk drive or solid state disk). Typically, when software believes it will need the data/instructions on a particular page, it will fetch the page from mass storage and store it into system memory. From there, the system software operates out of system memory when referencing to the data/instructions stored on the page. If the software believes the page's data/instructions are no longer needed, the page may be moved back down to mass storage from system memory.

The particular set of segments 221 through 225 of FIG. 2 may therefore correspond, e.g., to a group 201 of page storage segments having a near memory to far memory storage capacity ratio of 1:4. Other embodiments may have different ratios of faster system memory to slower system memory. Various other systems may use the segments 221 through 225 to store units of information other than pages. However, for ease of explanation, the present discussion will refer mainly to pages as the units of information that are kept in the different segments 221 through 225.

As mentioned above, the near memory segment 221 may act as a faster region of system memory, or, as a region to cache pages from any of segments 222 through 225. Here, as described in more detail further below, the system intelligently chooses between the two different uses of segment 221 based on system state. Additionally, as also will be described in more detail below, the system may swap the relationship between a logical address that identifies a specific page that is kept within one of the segments of the group 201 and the actual physical address of the segment where the page is stored.

Here, traditionally, software identifies a specific page by its virtual address. The virtual address, in turn, is then translated (e.g. in hardware with a translation look-aside buffer (TLB) and/or in software with a virtual machine monitor (VMM)) ultimately to a specific physical address in system memory where the page is located. The different logical addresses used to identify different pages in the segments of group 201 of FIG. 2 may be, e.g., a virtual address or the output of a translation look-aside buffer depending on implementation.

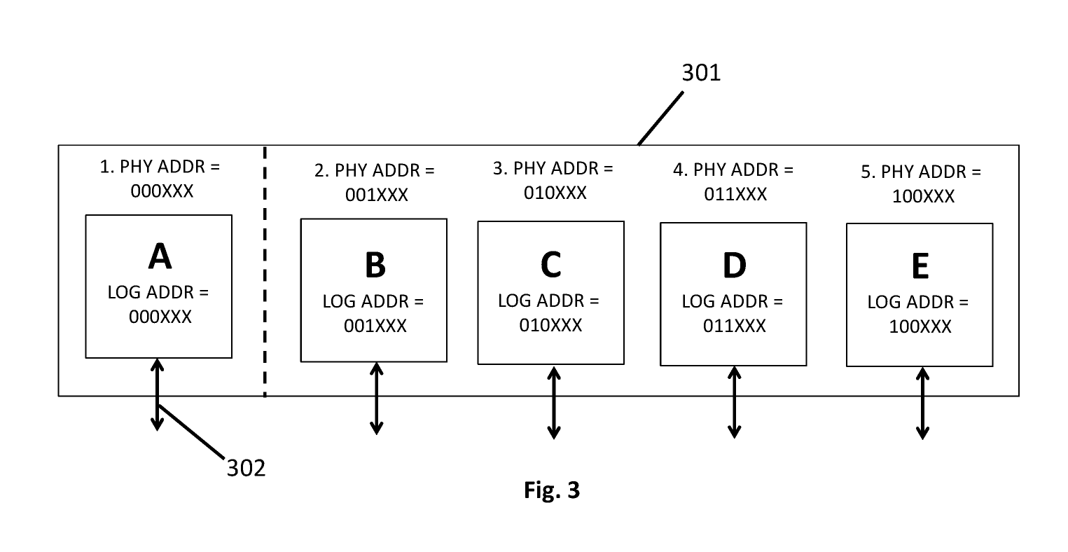

Here, referring to FIG. 3, pages A through E are kept in segments 221 through 225, respectively. In a basic or standard state, the logical address that is used to identify a particular page matches the physical address where the page is kept. As can be seen in FIG. 3, page A is identified with logical address 000XXX and is being kept in the segment 221 having physical address 000XXX. As such, the logical address 000XXX may correspond to the translated output address from a translation look aside buffer in response to a virtual address.

By contrast, in other embodiments, the logical address that identifies a particular page may correspond to a virtual address and the assignment of the particular page to a particular segment within the group 201 corresponds to some or all of the translation of a virtual address to a physical address. For example, if page A were to be stored in segment 223 (a possibility that is described in more detail further below), the process of assigning page A to a segment other than a segment having the same base address may be part of the overall translation performed by the system of virtual addresses into physical addresses.

As such, the processes and techniques described herein may be performed entirely in software, entirely in hardware, or some combination of the two. More specifically, referring briefly back to FIG. 1, a computing system can be viewed as having a host side processing system that includes the processing cores 117 and memory controller 116. The host side processing system is designed to switch between utilization of near memory as a cache for the far memory and separately addressable system memory depending on the state of a computing system. Any of the various processes described below may be performed entirely by the software of the system, the hardware of the system or some combination of the two. For example, the memory controller 116 may include special logic circuitry to perform any/all of the tasks described below.

FIG. 3 shows a base state where pages A through E are kept in the segments of the group 201 having a physical address that matches their own logical address. In this state the system operates out of the group by individually referring to information items (e.g., cache lines of data or instructions) that are kept in the pages by referencing their logical addresses. For instance if access to a cache line from page A is desired, the request for access to the cache line will include an address of the form 000XXX. Likewise, if access to a cache line from page E is desired, the request for access to the cache line will include an address of the form 100XXX. With the system actually operating out of each segments 221 through 225, FIG. 3 represents such operational activity with read/write accesses such as accesses 302 for segment 221.

In the state of FIG. 3, note that different pages are resident in the different segments. As such, near memory segment 221 is not acting as a cache for any of far memory segments 222 through 225. That is, whereas far memory segments 222 through 225 are respectively keeping pages B through E, by contrast, near memory segment 221 is keeping page A. In this case, near memory segment 221 is acting as a faster region of system memory having a uniquely allocated logical address range that it supports (the logical address range 000XXX of page A).

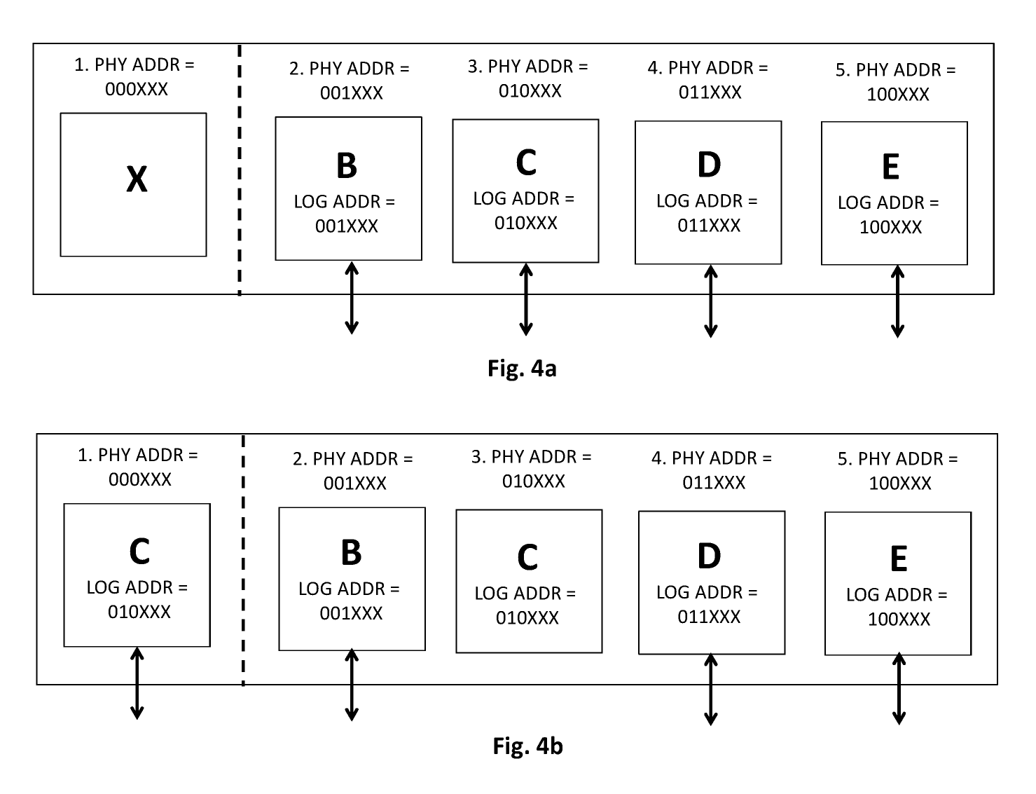

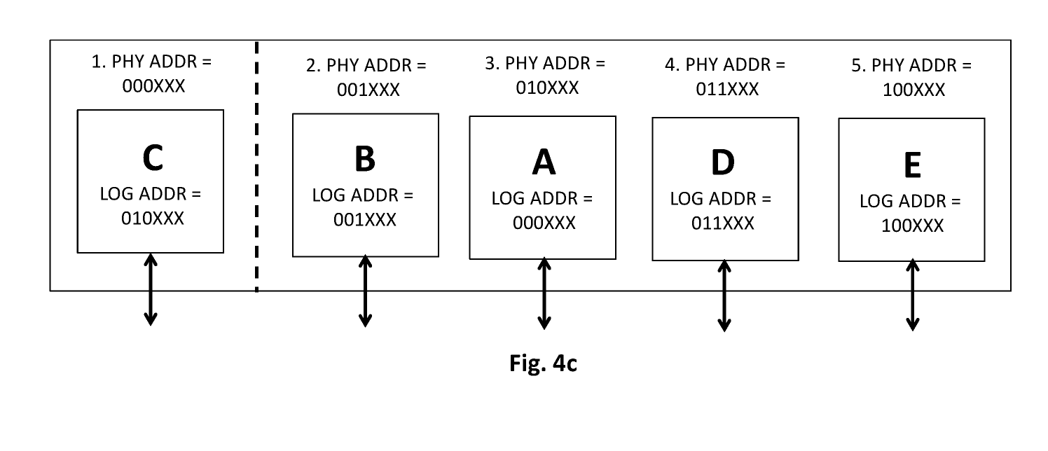

FIGS. 4a through 4c, by contrast, show a sequence where near memory segment 221 acts as a cache for one of the far memory segments 222 through 225 rather than a separately allocated region of system memory. FIG. 4a represents the state of the system after the state of FIG. 3 after system software has sent page A from system memory back to mass sector/base storage. As such, after the de-allocation of page A from system memory back to mass storage, no page has been allocated to operate out of segment 221. In this case, the system software has not called a page of information up from mass sector/block storage to occupy segment 221. As such, no access activity is depicted for segment 221 in FIG. 4a. By contrast, each of the far memory segments 222 through 225 contain a page and are active. In an embodiment the instruction set architecture is expanded to include an instruction ISA-free that signifies to the hardware that the OS or VMM has freed a page in system memory. In this case, the ISA-free instruction would be executed to indicate that the memory region where page A was kept is now free (e.g., by executing ISA-free with logical address 000XXX which is translated to physical address 000XXX).

Recognizing the state of FIG. 4a, the system can decide to use segment 221 as a cache region for one of the far memory segments 222 through 225. Here, the system may keep statistics on the various pages within the group and choose to operate the more frequently accessed page out of segment 221. Here, referring to FIG. 4b, the system has decided that accesses to page C have been sufficiently more frequent to justify moving the content of page C from memory segment 223 to segment 221 (the content of page C as of the time of the move remains in segment 223). Here, when a system memory access having logical address 010XX is generated, the access will be targeted to near memory segment 221 rather than far memory segment 223. So doing will result in faster performance for accesses directed to page C. As such, comparing FIG. 4b with FIG. 4a, note that read/write activity is observed to begin for segment 221 but cease for segment 223. In essence, the translation of the logical address for page C has changed from being directed to slower segment 223 to being directed to faster segment 221. In an embodiment the instruction set architecture is expanded to include an instruction ISA-alloc that signifies to the hardware that the OS or VMM has allocated a page in system memory. In this case, the ISA-alloc instruction would be executed to indicate that the memory region where page C is to be kept has been allocated (e.g., by executing ISA-alloc with logical address 010XXX which is translated to physical address 000XXX).

Referring to FIG. 4c, the system has subsequently chosen to allocate page A. According to one embodiment, because page C as cached in segment 221 has remained active and now contains different data that its counterpart in segment 223 (e.g., because of frequent writes to page C after it was cached in near memory segment 221), page A is allocated to operate out of segment 223 rather than segment 221. Each of segments 221 through 225 now show read/write access activity. Also, again, the translation between logical address and physical address has been changed to cause page A having base address 000XXX to be kept in segment 223 having physical address 010XX. Comparing the state of the system in FIG. 4c with the state of the system in FIG. 3, note that the logical to physical address translations for pages A and C have been effectively swapped. Again, the ISA-alloc instruction may be executed to indicate that the memory region where page A is to be kept has been allocated (e.g., by executing ISA-alloc with logical address 000XXX which is translated to physical address 010XXX).

FIGS. 4a through 4c discussed possible behavior of a system that is conscious of the performance advantage of near memory over far memory and that can alter logical to physical mappings in order to promote more active pages to near memory.

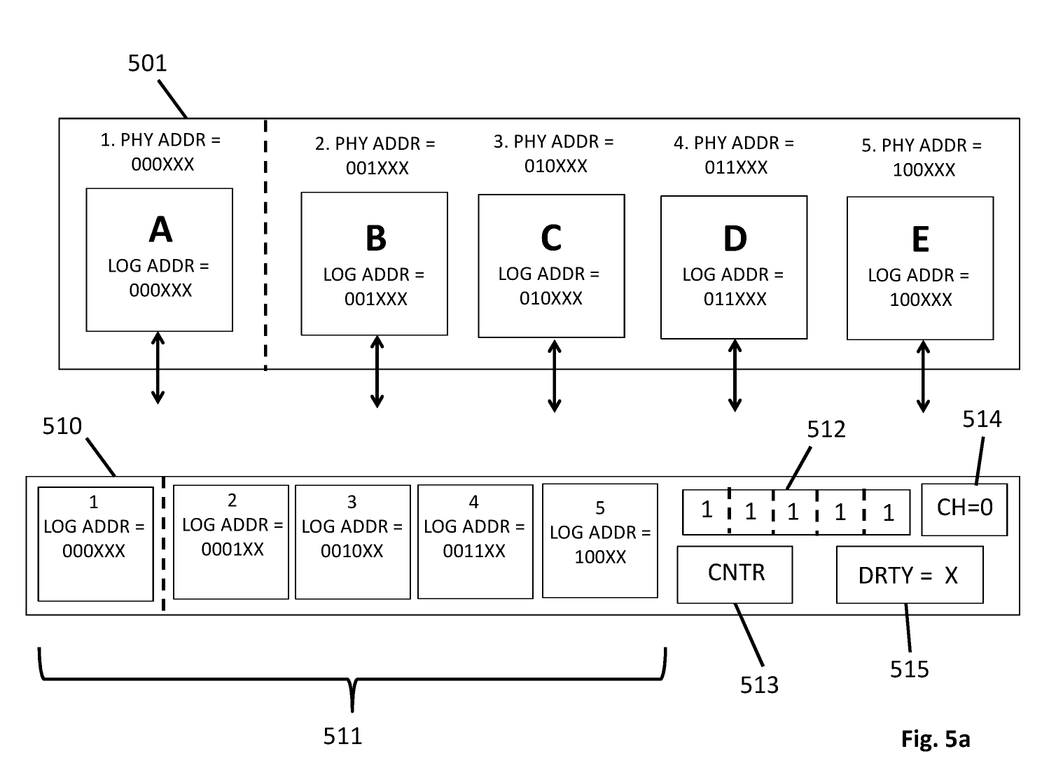

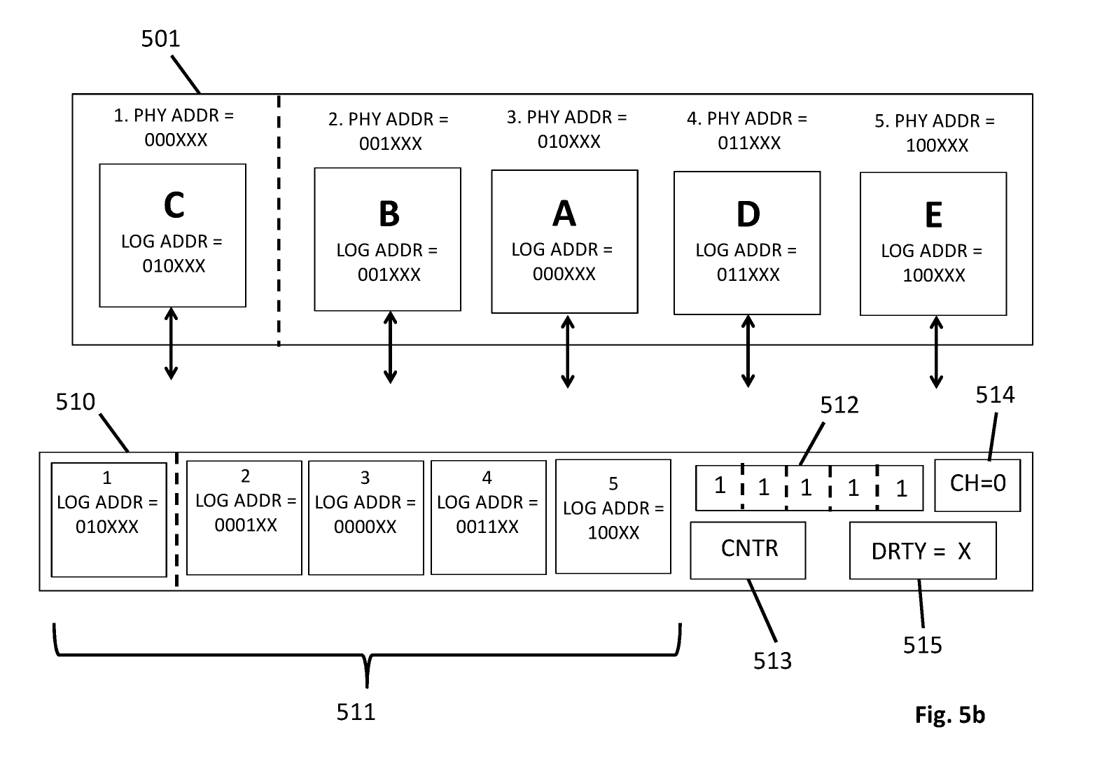

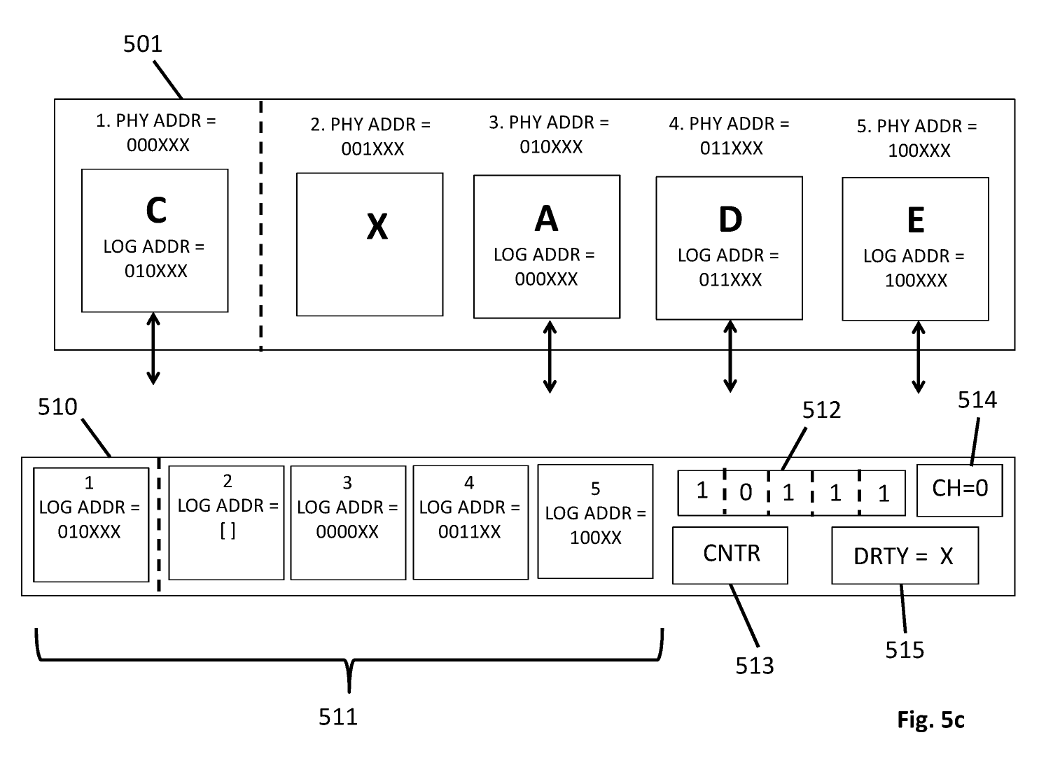

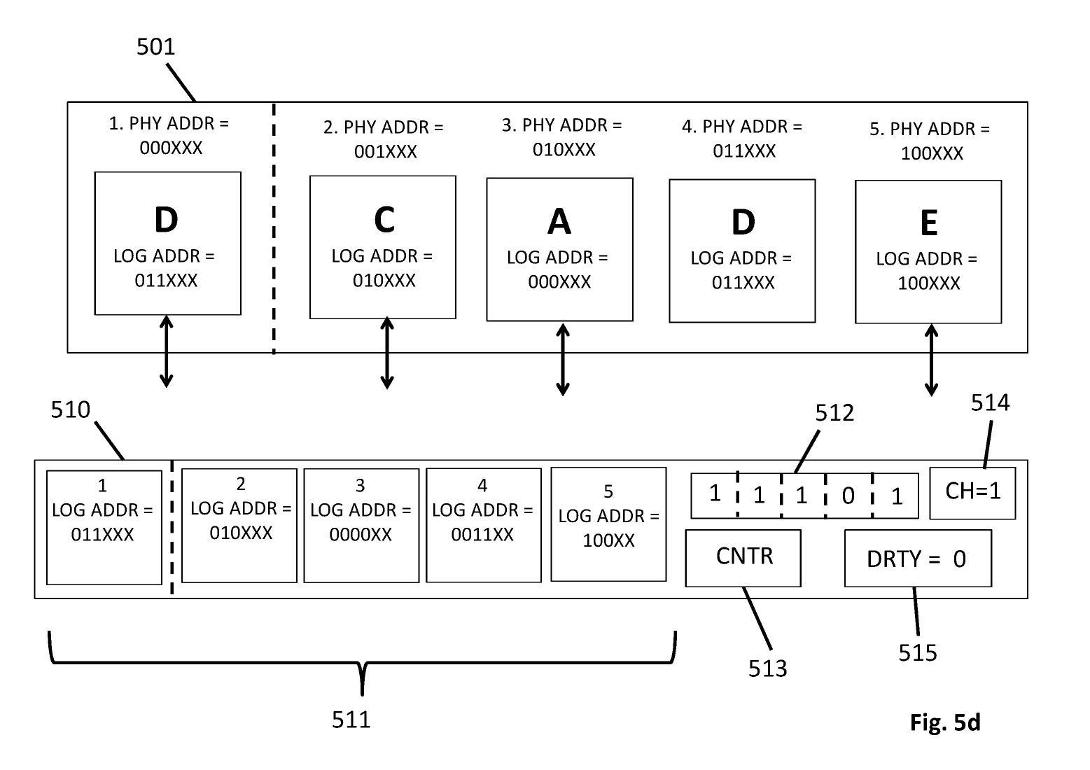

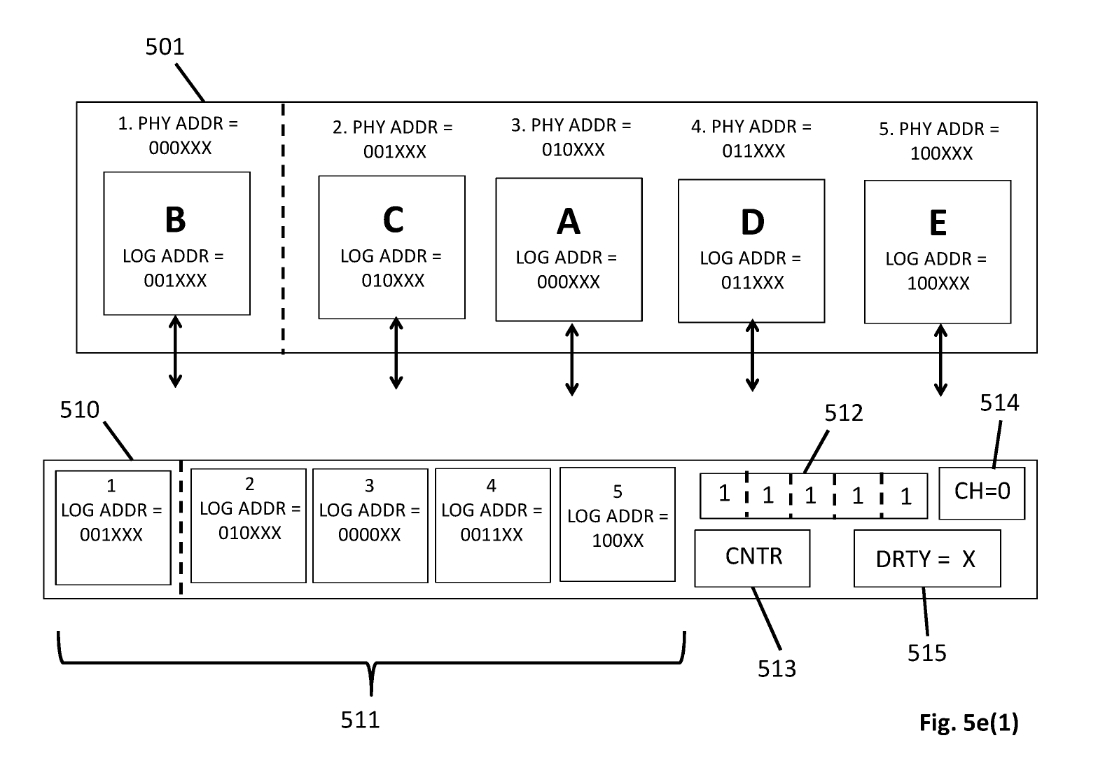

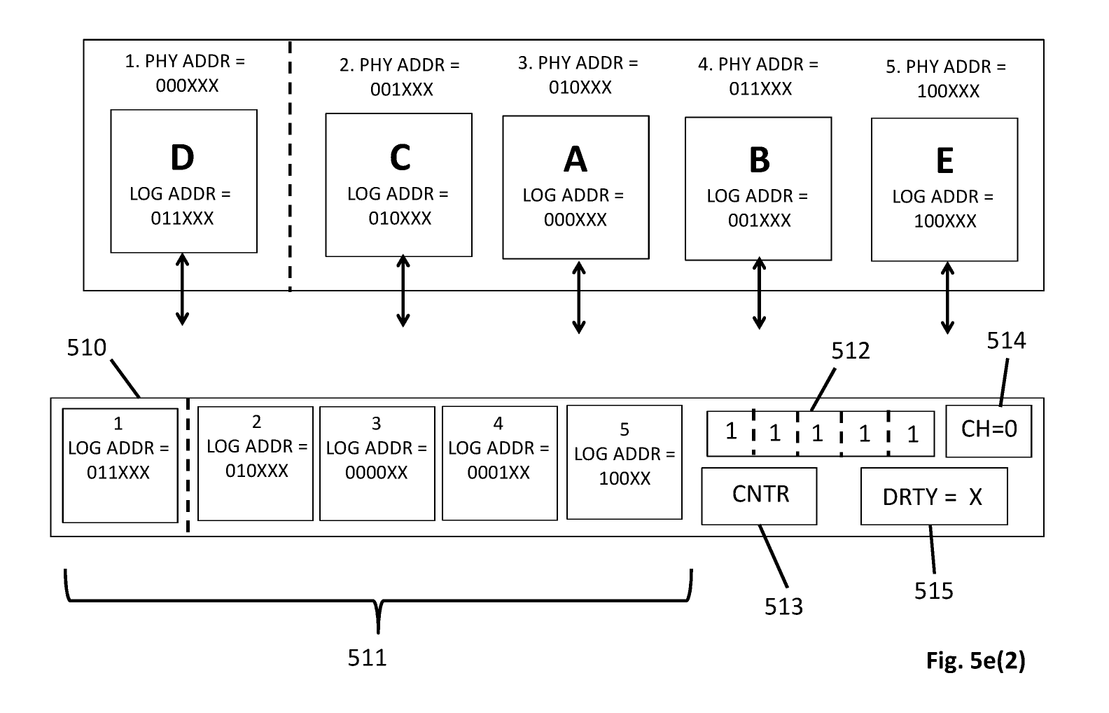

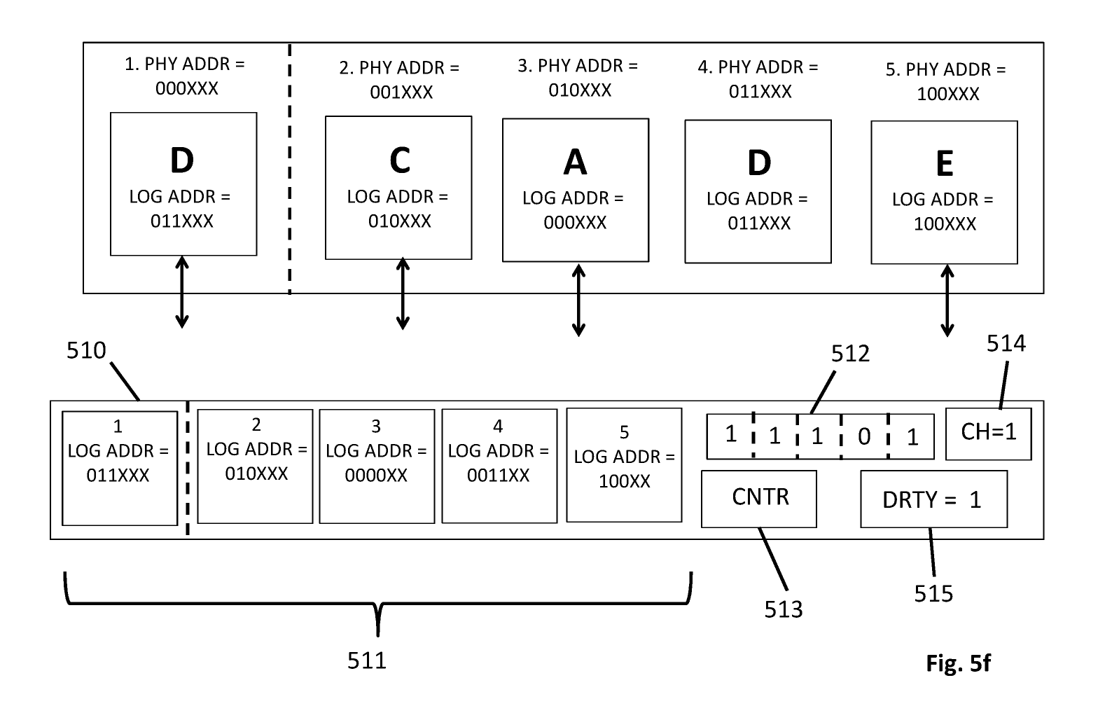

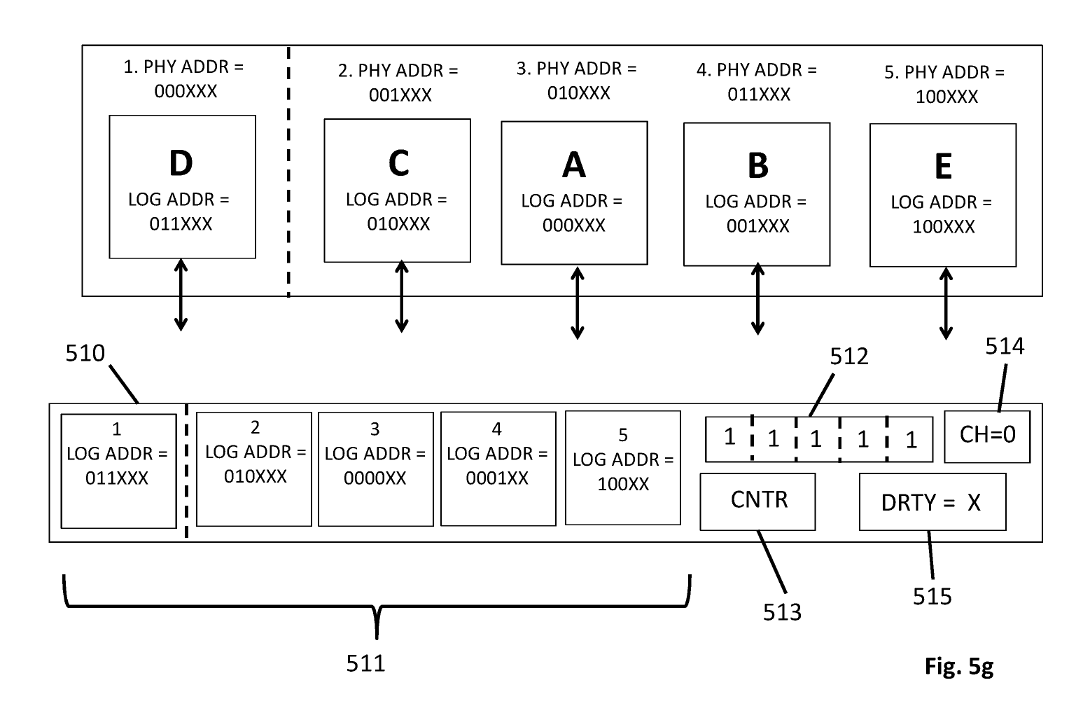

FIGS. 5a through 5g depict a more detailed implementation example that includes not only the behavior of page manipulation but also a table entry used to keep track of page allocations and other information that can be used by the system to make specific decisions as to which pages should be kept in which segments.

FIG. 5a shows a segment group 501 and a table entry 510 used to control the allocation of various pages that are assigned to operate out of the segment group. Here, note that an entire system memory of a computing system memory may be composed of many different segment groups like segment group 501. Correspondingly, a complete table structure having many entries like entry 510 (e.g., one entry in the table per segment group in system memory) may be used to control allocation of pages to specific segments throughout operation of the system and system memory.

As observed in FIG. 5a, the table entry 510 includes different fields 511 for each of the physical segments of the segment group 501 within system memory that the entry 510 corresponds to. Here, a specific physical address is assumed to be known for each segment. In the specific example of FIG. 5a, segment 1 is known to have physical address 000XXX, segment 2 is known to have physical address 001XXX, etc. This information may be contained, e.g., within the respective fields 511 of the table entry 510. For illustrative ease such information is not shown in FIG. 5a.

Each of the fields 511 also contains the logical address of the specific page that is allocated to operate out of its corresponding segment. From entry 510 in FIG. 5a, page A having logical address 000XXX is understood to be allocated to segment 1, page B having logical address 001XXX is understood to be allocated to segment 2, etc.

The table entry 510 also includes a dedicated memory addressing structure 512 that includes a one bit field for each segment in the segment group that indicates whether its corresponding segment is supporting a separate system memory address range that the system is currently operating out of. As indicated in FIG. 5a, all five segments of the segment group 501 are supporting their own unique system memory address range that the system is operating out of. As such, all five bits in data structure 512 have a value of “1”.

A counter 513 is also included in the table entry 510 whose value(s) indicate which of the pages in the segment group 501 are most active. That is, counter 513 keeps one or more values that indicate which one of the pages in segments 1 through 5 is receiving the most read/write hits. The counter 513 can be used, for instance, to place the page having the most hits into the near memory segment (segment 1). The counter 513 may keep a separate count value for each segment/page, or use competing counter structures to reduce the size of the tracked count values. In the case of a competing counter structure, the counter structure 513 keeps a first value that is a relative comparison of the number of hits between two pages (e.g., each hit to the first page increments the counter and each hit to the second page decrements the counter).

The counter structure 513 also includes information that counts hits for each competing page pair as a whole so that a final determination as to which page received the most hits amongst all pages in the segment group can ultimately be determined. In the case of a segment group having five segments there would exist two competing counters to account for four of the pages and a third competing counter that tallies a competing count between the fifth page and one of the other four pages. Two additional counters may also be included to determine relative hit counts between the three competing counters so that the page having the most hits can be identified.

The table entry 510 also includes a cache bit 514 that indicates whether near memory is being used to cache for the content of another segment. As observed in FIG. 5a, segment 1 (the near memory segment) is not being used as a cache for another segment (i.e., the CH value is set to 0).

The table entry 510 also includes a dirty bit 515 which indicates whether a cached page in the near memory segment (segment 1) has been written to or not. As stated just above, in the system state of FIG. 5a, the near memory segment is not being used to cache a page. However, if the near memory segment were being used to cache a page, the dirty bit 515 would be used to determine whether the data of the cached page can be directly overwritten with the content of another page or cannot be directly overwritten with the content of another page. Here, if the dirty bit 515 bit is set (which indicates the page has been written to), the cached page cannot be directly overwritten (its content must be saved because it contains the most recent data for the page). By contrast if the dirty bit 515 is not set, the cached page can be written to (not having been written to, a duplicate copy of the cached page resides in one of the far memory segments).

Referring to FIG. 5b, pages and A and C have been swapped. Here, for instance, from the state of the system in FIG. 5a, the counter value 513 may have been analyzed which revealed that page C is receiving substantially more read/write hits than page A. As such, page C was moved into the near memory segment (segment 1) to give better performance to the more heavily access page. Likewise, page A was demoted to the far memory segment where page C was originally allocated to give lesser performance to lesser accessed page A. The segment fields 511 are updated as part of the page swap to reflect that page C having logical address 010XXX is now in segment 1 and page A having logical address 000XXX is now in segment 3.

Referring to FIG. 5c, page B is de-allocated from the segment group 501 (e.g., it was moved down to mass storage). As such, the segment fields 511 are updated to reflect that no page is currently being kept in segment 2. That is, the logical address for the segment 2 portion of the segment fields 511 contains a null value. Because segment 2 is no longer supporting its own unique system memory address space that the system is currently operating out of, the bit of the dedicated memory address range structure 512 that corresponds to segment 2 is changed from a 1 to a 0. Because segment 2 is not being actively used, no read/write activity is shown operating out of segment 2 within the segment group 501.

Referring to FIG. 5d, with the dedicated memory address range 512 now revealing that one of the segments in far memory is not currently being utilized, the system can recognize that an opportunity exists to use far memory for caching of a page that resides in far memory. Here, assuming that the counter 513 also reveals that page D is now receiving more read/write hits than page C, page C is demoted to far memory and is written into previously non-utilized segment 2. A copy of page D is then written into near memory segment 1. The segment fields 511 of the table entry 510 are therefore updated to show that page D having logical address 011XXX is now kept in near memory segment 1 and that page C having logical address 010XXX is now kept in far memory segment 2.

Furthermore, the cache bit 514 is updated to reflect that the segment group 501 is now acting in a caching mode. In caching mode, the far memory version of the page that is in near memory cache is not accessed. Rather all read/write activity for the page is directed to its near memory version in segment 1. As such, the version of the page that is in far memory is not uniquely supporting a system memory address range that the system is operating out of. As such, the section of the dedicated memory address structure 512 that corresponds to the dormant version of page D that is presently kept in far memory segment 4 is changed to a value of 0.

When in caching mode, as reflected by the assertion of field 514, the system will know to resolve a conflict of two identical logical addresses in the segment fields 511 in favor of the entry in near memory segment 1. That is, from the state of FIG. 5d, an incoming memory request having logical address 011XXX will match on the fields for both segments 1 and 4. In caching mode, the system mode will know to direct such requests to segment 1 and not segment 4. As of the state of FIG. 5d, the cached page D in segment 1 has not yet been written to. As such, the dirty bit 515 remains un-asserted at 0. Because the far memory version of page D in segment 4 is not actively being used, no active read/write activity is depicted for segment 4 in the segment group 501 of FIG. 5d.

FIGS. 5e(1) and 5e(2) depict a possible sequence than can occur from the state of FIG. 5d if the dirty bit remains un-asserted and the system decides to re-allocate page B back into the segment group 501 (e.g., page B is called up from mass storage into system memory). As observed in FIG. 5e(1), because the dirty bit is not set, the cached version of page D in near memory segment 1 can be directly overwritten with the content of newly recalled page B. Here, segment fields 511 are updated to reflect that page B having logical address 001XXX is now present in segment 1. Also, as of the state of FIG. 5e(1), all segments are now supporting their own unique system memory address range. As such, the dedicated system memory address range data structure 512 shows all is in its respective fields. Likewise, the cache bit 514 has been cleared since the system is no longer using the near memory segment as a cache. With the cache bit 514 being cleared, the system does not care what the value of the dirty bit 515 is.

Page B may be automatically written into near memory as depicted in FIG. 5e(1) rather than far memory because the system may opportunistically expect more activity to page B since it was just called up from mass storage. FIG. 5e(2) shows a later event in which the counter 513 has revealed that the opportunistic assumption was incorrect and page D is still yielding more hits than newly recalled page B. In that case, as shown in FIG. 5e(2), the system can swap pages B and D so that page D operates out of near memory segment 1 and page B operates out of far memory segment 4.

FIGS. 5e(1) and 5e(2) were directed to a possible sequence if the dirty bit 515 for cached page D was not set when page B was recalled into the segment group 501. By contrast, FIG. 5f shows a change from the stage of FIG. 5d in that the dirty bit 515 has been set in FIG. 5f meaning cached page D in near memory segment 1 has been written to since the state of FIG. 5d. Because cached page D in near memory segment 1 has been written to, it cannot be directly overwritten by newly recalled page B. As such, as shown in FIG. 5g, newly recalled page B is directly written over the far memory version of page D that was being kept in segment 4. So doing avoids the inefficiency of having to write the cached version of page D in near memory segment 1 back into segment 4.

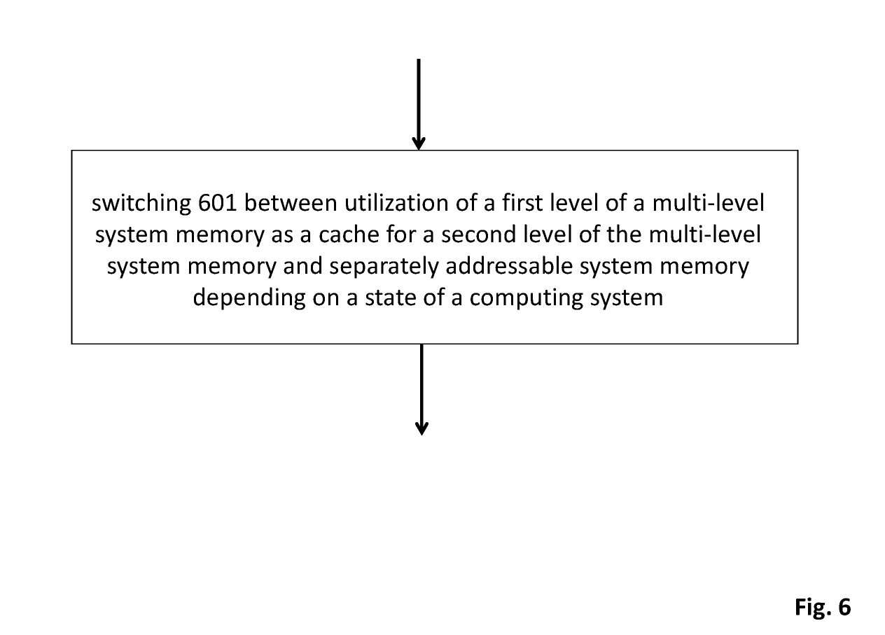

FIG. 6 shows a methodology. The methodology may include switching 601 between utilization of a first level of a multi-level system memory as a cache for a second level of the multi-level system memory and separately addressable system memory depending on a state of a computing system.

Although embodiments discussed above were directed to embodiments where near memory was assumed to have smaller access times than far memory, in other embodiments, far memory may possess other characteristics on top of or in lieu of smaller access times that, e.g., make it more attractive for handling e.g., higher priority or more active pages, such as having a higher bandwidth and/or consuming less power than far memory. Also, although embodiments described above were directed to a 1:N mapping of near memory pages to far memory pages in a particular page group, other page group embodiments may be designed to include 2:N, 3:N, etc. near memory to far memory page mappings.

### 3.0 Computing System Embodiments

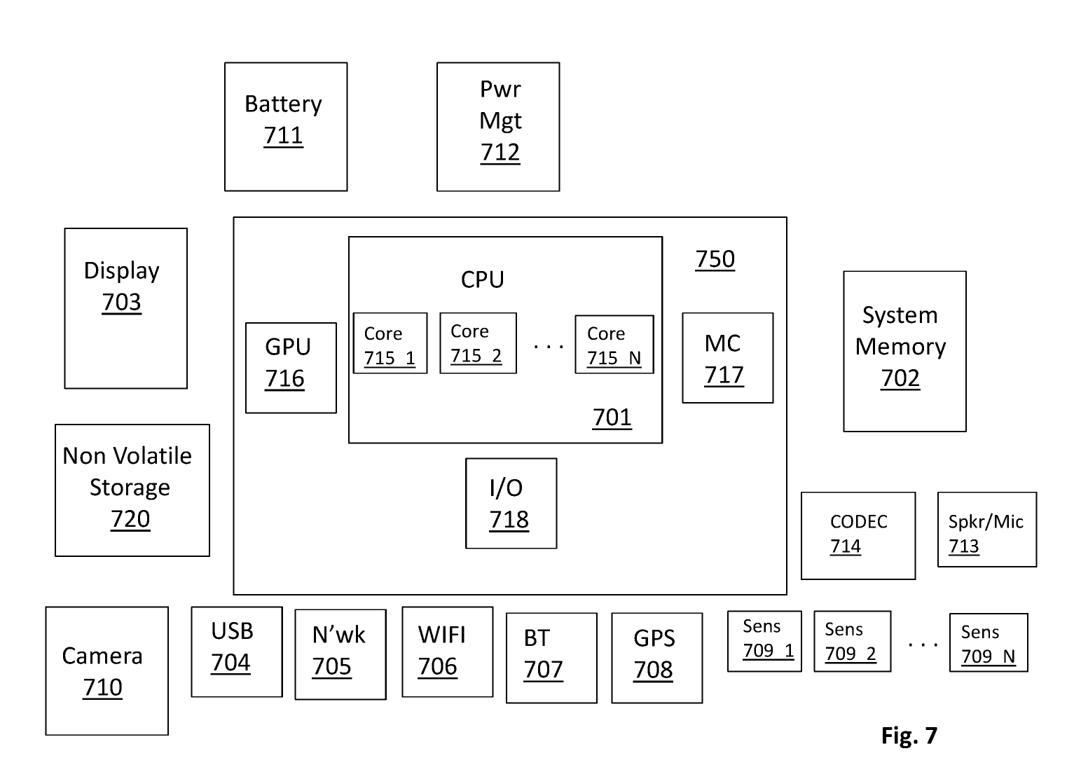

FIG. 7 shows a depiction of an exemplary computing system 700 such as a personal computing system (e.g., desktop or laptop) or a mobile or handheld computing system such as a tablet device or smartphone, or, a larger computing system such as a server computing system. As observed in FIG. 7, the basic computing system may include a central processing unit 701 (which may include, e.g., a plurality of general purpose processing cores and a main memory controller disposed on an applications processor or multi-core processor), system memory 702, a display 703 (e.g., touchscreen, flat-panel), a local wired point-to-point link (e.g., USB) interface 704, various network I/O functions 705 (such as an Ethernet interface and/or cellular modem subsystem), a wireless local area network (e.g., WiFi) interface 706, a wireless point-to-point link (e.g., Bluetooth) interface 707 and a Global Positioning System interface 708, various sensors 709_1 through 709_N (e.g., one or more of a gyroscope, an accelerometer, a magnetometer, a temperature sensor, a pressure sensor, a humidity sensor, etc.), a camera 710, a battery 711, a power management control unit 712, a speaker and microphone 713 and an audio coder/decoder 714.

An applications processor or multi-core processor 750 may include one or more general purpose processing cores 715 within its CPU 701, one or more graphical processing units 716, a memory management function 717 (e.g., a memory controller) and an I/O control function 718. The general purpose processing cores 715 typically execute the operating system and application software of the computing system. The graphics processing units 716 typically execute graphics intensive functions to, e.g., generate graphics information that is presented on the display 703. The memory control function 717 interfaces with the system memory 702. The system memory 702 may be a multi-level system memory such as the multi-level system memory discussed at length above. The host side processing cores 715 and/or memory controller 717 may be designed to switch near memory resources of the multi-level system memory between acting as a cache for far memory and acting as separately addressable system memory address space depending on system state as discussed at length above.

Each of the touchscreen display 703, the communication interfaces 704-707, the GPS interface 708, the sensors 709, the camera 710, and the speaker/microphone codec 713, 714 all can be viewed as various forms of I/O (input and/or output) relative to the overall computing system including, where appropriate, an integrated peripheral device as well (e.g., the camera 710). Depending on implementation, various ones of these I/O components may be integrated on the applications processor/multi-core processor 750 or may be located off the die or outside the package of the applications processor/multi-core processor 750.

Embodiments of the invention may include various processes as set forth above. The processes may be embodied in machine-executable instructions. The instructions can be used to cause a general-purpose or special-purpose processor to perform certain processes. Alternatively, these processes may be performed by specific hardware components that contain hardwired logic for performing the processes, or by any combination of software or instruction programmed computer components or custom hardware components, such as application specific integrated circuits (ASIC), programmable logic devices (PLD), digital signal processors (DSP), or field programmable gate array (FPGA).

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. An apparatus, comprising:
a host side processing system to interface with a multi-level system memory, the host side processing system comprising at least one processing core and a memory controller, the multi-level system memory having a first level and a second level, the host side processing system is to switch between utilization of the first level as a cache for the second level and separately addressable system memory depending on a state of a computing system that the host side processing system and the multi-level system memory are components of.

2. The apparatus of claim 1 wherein the host side processing system is to view the multi-level system memory as comprising a group of units of memory space, where, a unit of memory space in the group in the first level is able to switch between acting as a cache for a plurality of other units of memory space in the group in the second level and acting as a separately addressable unit of addressable system memory space, depending on system state.

3. The apparatus of claim 2 wherein the units of memory space are to store respective pages of information.

4. The apparatus of claim 2 wherein, when the unit of memory space is keeping information and is acting as the cache, the host side processing system is permitted to write over a second version of the information that is being kept in one of the units of memory space with second information whose address maps to the group.

5. The apparatus of claim 2 wherein, the host side processing system is to put most frequently accessed unit of information in the group into the unit of memory space.

6. The apparatus of claim 5 wherein the put, if another unit of information is being kept in the unit of memory space before the put, causes the another unit of information to be moved to one of the other units of memory space if the another unit of information is dirty.

7. The apparatus of claim 2 wherein the host side processing system is to keep track of a data structure that identifies which units of information that map to the group are kept in which units of memory space in the group.

8. The apparatus of claim 7 wherein the data structure includes counter information to identify which of the units of information is most frequency accessed.

9. The apparatus of claim 7 wherein the data structures includes information that specifies whether the unit of information is acting as a cache or as a separately addressable unit of addressable memory space.

10. The apparatus of claim 1 wherein hardware of the host side processing system controls switching between utilization of the first level as a cache for the second level and separately addressable system memory depending on the state of the computing system.

11. A computing system, comprising:
a network interface;
a multi-level system memory having a first level and a second level;
a host side processing system, the host side processing system comprising a memory controller that is coupled to the multi-level system memory, the host side processing system comprising a plurality of processing cores coupled to the memory controller, the host side processing system to switch between utilization of the first level as a cache for the second level and separately addressable system memory depending on a state of a computing system that the host side processing system and the multi-level system memory are components of.

12. The computing system of claim 11 wherein the host side processing system is to view the multi-level system memory as comprising a group of units of memory space, where, a unit of memory space in the group in the first level is able to switch between acting as a cache for a plurality of other units of memory space in the group in the second level and acting as a separately addressable unit of addressable system memory space, depending on system state.

13. The computing system of claim 12 wherein the units of memory space are to store respective pages of information.

14. The computing system of claim 12 wherein, when the unit of memory space is keeping information and is acting as the cache, the host side processing system is permitted to write over a second version of the information that is being kept in one of the units of memory space with second information whose address maps to the group.

15. The computing system of claim 12 wherein, the host side processing system is to put most frequently accessed unit of information in the group into the unit of memory space.

16. The computing system of claim 15 wherein the put, if another unit of information is being kept in the unit of memory space before the put, causes another unit of information to be moved to one of the other units of memory space if the another unit of information is dirty.

17. The apparatus of claim 12 wherein the host side processing system is to keep track of a data structure that identifies which units of information that map to the group are kept in which units of memory space in the group.

18. A method, comprising:
performing the following in a computing system having a multi-level system memory, the multi-level system memory having a first level and a second level:
switching between utilization of the first level as a cache for the second level and separately addressable system memory depending on a state of the computing system.

19. The method of claim 18 wherein the multi-level system memory comprises a group of units of memory space, where, a unit of memory space in the group in the first level is able to switch between acting as a cache for a plurality of other units of memory space in the group in the second level and acting as a separately addressable unit of addressable system memory space, depending on system state.

20. The method of claim 19 further comprising keeping track of a data structure that identifies which units of information that map to the group are kept in which units of memory space in the group.

21. The method of claim 19 further comprising putting a most frequently accessed unit of information in the group into the unit of memory space.

22. A machine readable storage medium containing program code that when processed by a computing system having a multi-level system memory, the multi-level system memory having a first level and a second level, causes the computing system to perform a method, the method comprising:
switching between utilization of the first level as a cache for the second level and separately addressable system memory depending on a state of the computing system.

23. The machine readable storage medium of claim 18 wherein the multi-level system memory comprises a group of units of memory space, where, a unit of memory space in the group in the first level is able to switch between acting as a cache for a plurality of other units of memory space in the group in the second level and acting as a separately addressable unit of addressable system memory space, depending on system state.

24. The machine readable storage medium of claim 19 further comprising keeping track of a data structure that identifies which units of information that map to the group are kept in which units of memory space in the group.

25. The machine readable storage medium of claim 19 further comprising putting a most frequently accessed unit of information in the group into the unit of memory space.
